(19) United States
(12) Patent Application Publication
(10) Pub. No.: US 2023/0248167 A1
(43) Pub. Date: Aug. 10, 2023

(54) EGGSHELL PEELING APPARATUS

(71) Applicant: Ricky Tam, Hong Kong (HK)

(72) Inventor: Ricky Tam, Hong Kong (HK)

(21) Appl. No.: 18/163,893

(22) Filed: Feb. 3, 2023

Related U.S. Application Data
(60) Provisional application No. 63/308,047, filed on Feb. 8, 2022.

(51) Int. Cl. A47G 19/28; A23L 15/00

(52) U.S. Cl. CPC A47G 19/28; A23L 15/00

(57) ABSTRACT

An apparatus for assisting in removal of the eggshell of an hardboiled egg comprising a first body, a second body detachably couplable to the first body, upon coupling the first and second bodies form an inner cavity for receiving a hardboiled egg, wherein the inner cavity comprises an inner wall complementary to the shape of the hardboiled egg, the inner cavity is arranged to provide a space between the hardboiled egg and the inner wall, and the eggshell peeling apparatus further comprises at least one water outlet in fluidic communication with the inner cavity. A method of peeling eggshell of a hardboiled using the said apparatus is also disclosed.

### CROSS REFERENCE TO RELATED APPLICATIONS

The present application claims the benefit of U.S. Provisional Patent Application No. 63/308,047 filed on Feb. 8, 2022, the contents of which are incorporated herein by reference in their entirety.

### FIELD OF THE INVENTION

The present invention relates to an eggshell peeling apparatus for assisting removal of the eggshell from a hardboiled egg. In particular, the present invention provides an apparatus for loosening or separating the eggshell from a hardboiled egg for ease of subsequent removal.

### BACKGROUND

Peeling hardboiled eggs with bare hands is a tedious process, especially when peeling hot and fragile hardboiled eggs with bare hands. Additionally, although the process of peeling eggs does not require a lot of time for most people, it is nonetheless a time-consuming process for some people, i.e., elderly with less agile hands, especially when peeling more than one or a few hardboiled eggs that are still too warm to touch.

Known eggshell removal machines or devices on the market, which are configured for processing a mass number of eggs, are not suitable for general households or consumers who only require to peel one to several hardboiled eggs. Moreover, said machines or devices usually have a large footprint making them not practical for household use. There are some other devices on the market that aim to provide removal of eggshells from hardboiled eggs, but they are not satisfactorily effective.

Commonly, these known eggshell removal devices would have a cavity for receiving a hardboiled egg. Usually, the cavity would be provided with one or more protrusions, such as an annular shoulders or bumps. To break the eggshell of a hardboiled egg, the egg is placed in the cavity, while the user shakes the device to cause the hardboiled egg inside the cavity to collide with the one or more protrusions for the purpose of fracturing the eggshell. If the device is shaken too hard, the protrusions may cause fragments of eggshell to pierce into the egg white, let alone the protrusions may also rupture the fragile bare egg underneath the eggshell. This can greatly reduce the success rate of having a peeled egg intact. Furthermore, after inserting the hardboiled egg into the device, the user must be skillful when applying force for shaking the device, since too much force applied when shaking would burst the egg white, while too little force would be unable to crack or loosen the eggshell sufficiently to allow easy peeling.

According to these devices, the cavities of these devices do not conform to the shape of the hardboiled egg, which will more likely to cause uneven collisions within the cavity when collision is taking place. This will likely to result in having fragments of the eggshell still being attached to the surface of the hardboiled egg, but with some other fragments pierced into the egg white. In view of the above, there exists the need for an apparatus for general household that can operate to loosen or separate the eggshell of a hardboiled egg easily and quickly while mitigating or at least alleviating at least the above shortcomings of existing devices.

### SUMMARY OF THE INVENTION

It is an object of the present invention to provide an apparatus that assist in loosening or separating the eggshell from a bare hardboiled egg prior to manually removing the fractured eggshell by hand. Other objects of the present invention are to provide an eggshell peeling apparatus which is of simple construction, inexpensive to manufacture and efficient in operation.

According to a first aspect of the invention, there is provided an apparatus for assisting removal of the eggshell of a hardboiled egg, comprising:

a first body portion;

a second body portion detachably couplable to the first body portion, upon coupling the first and second body portions form an inner cavity for receiving a hardboiled egg;

wherein the inner cavity comprises an inner wall complementary to the shape of the hardboiled egg, the inner cavity is arranged to provide a space between the hardboiled egg and the inner wall, and

the eggshell peeling apparatus further comprises one or more water outlets in fluidic communication with the inner cavity.

In an embodiment, the inner cavity has a three-dimension profile resembling an egg-shape, with the inner wall evenly surrounding the hardboiled egg received therein.

In another embodiment, the inner wall provides a collision surface, the collision surface is substantially smooth and free of protrusions.

In yet another embodiment, the inner cavity is arranged to receive a poultry egg of small to jumbo sizes.

Preferably, the inner cavity is further arranged such that a distance measured from the inner wall to a surface of the hardboiled egg does not exceed 5 mm on average.

In an embodiment, the first and second body portions are provided with first and second coupling ends, respectively, the first and second coupling ends are complementary to each other.

Preferably, the first and second coupling ends are arranged to prevent relative rotation between the first and the second body portions.

In an embodiment, the first and second coupling ends form a non-sealing junction between the first and second body portions.

In another embodiment, the one or more water outlets are formed at the non-sealing junction.

In yet another embodiment, the non-sealing junction has a wavy or zigzag shape extending around the circumference of the eggshell peeling apparatus.

Preferably, the inner cavity has a three-dimensional profile of an ovoid or a sphere.

More preferably, the first and the second body portions are made of glass or ceramic.

According to a second aspect of the invention, there is provided a method of removing an eggshell of a hardboiled egg comprising the steps of:

providing an apparatus according to the above;

placing the hardboiled egg in the second body portion;

filling the apparatus with water for providing a dampening effect for the collision between the eggshell and the inner wall;

coupling the first body portion with the second body portion with the first and second coupling ends in complement to each other;

shaking the apparatus thus fracturing the eggshell of the hardboiled egg;

separating the first body portion from the second body portion;

removing the hardboiled egg from the eggshell peeling apparatus; and

removing the fractured eggshell from the hardboiled egg,

wherein the step of shaking the apparatus causes the eggshell to collide repeatedly with the inner wall of the inner cavity while induces a gradual evacuation of the water through the one or more water outlets.

In an embodiment, the step of shaking the apparatus is performed in a direction substantially parallel to a longitudinal axis of the apparatus.

More preferably, the step of shaking the apparatus is completed only when the water in the apparatus has been substantially drained.

### BRIEF DESCRIPTION OF THE DRAWINGS

The present invention will now be more specifically described by way of example only with reference to the accompanying drawings, in which:

FIG. 1 shows an elevation view of an embodiment of the apparatus according to the present invention;

FIG. 2 shows a transparent view of the apparatus in FIG. 1;

FIG. 3 is a view illustrating a first body portion of the apparatus in FIG. 1;

FIG. 4 is a view illustrating a second body portion of the apparatus in FIG. 1; and

FIG. 5 and FIG. 6 are photographs illustrating a finished product of the apparatus produced in glass material.

### DESCRIPTION OF THE PREFERRED EMBODIMENTS

The following clearly and completely describes the technical solutions in the embodiments of the present invention with reference to the accompanying drawings. Apparently, the described embodiments are merely some but not all of the embodiments of the present invention. All other embodiments based on the embodiments of the present invention and obtained by a person of ordinary skill in the art without investing creative efforts shall fall within the scope of the present invention.

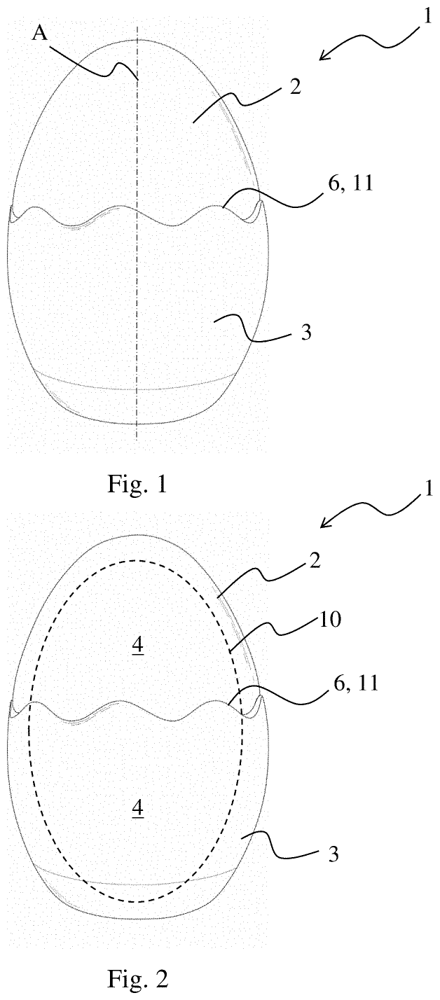

FIG. 1 to FIG. 6 illustrate an embodiment of the present invention that is an eggshell peeling apparatus for loosening eggshells of hardboiled eggs, hence allowing the eggshell of the hardboiled egg be peeled or removed manually easily by the user. Referring to FIG. 1 and FIG. 2, the eggshell peeling apparatus 1 comprises a two-part body including a first body portion 2 and a second body portion 3. For example, the first body portion 2 may be an upper portion of the two-part body while the second body portion 3 may be a lower portion of the two-part body. The second body portion 3 is detachably couplable to the first body portion 2. The fit between the first and the second body portions may be a snug fit or a loose fit. Upon the first and the second body portions 2, 3 are coupled together, the first and second body portions 2, 3 form an inner cavity 4 therewithin for receiving a hardboiled egg 10. Preferably, the apparatus 1 has a shape conforms to an egg or an ovoid, as shown.

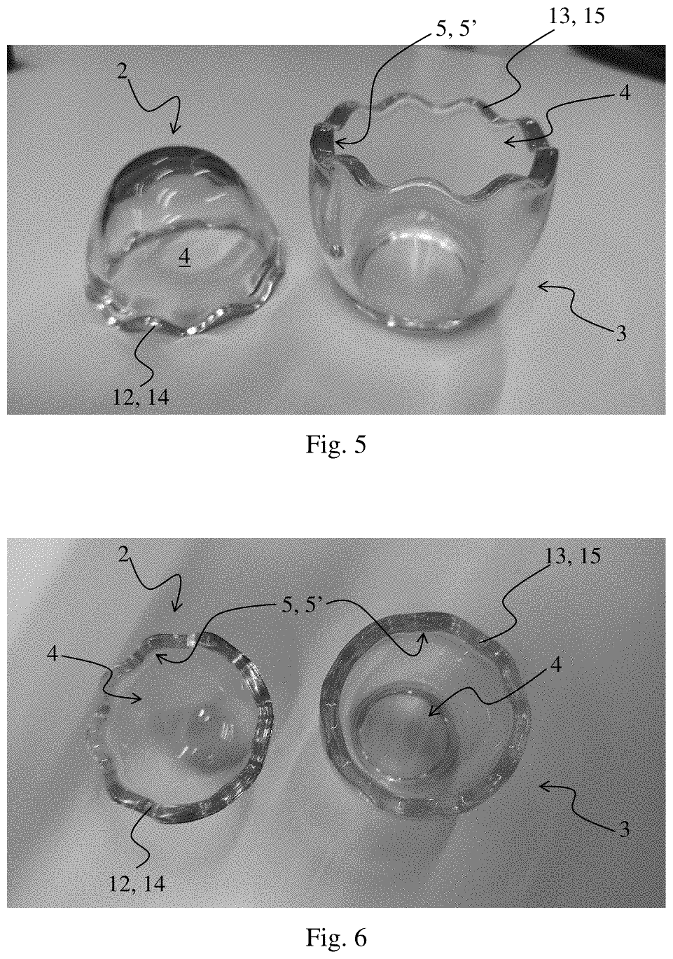

Referring to FIG. 5 and FIG. 6, the inner cavity 4 includes an inner wall 5 that is formed according to the shape of an egg that it receives. For example, the inner cavity 4 has a rounded inner wall 5 that complements with the shape of a hardboiled egg 10. Advantageously, the inner cavity 4 would be provided with a volume slightly larger than that of the hardboiled egg 10 such that when the hardboiled egg 10 is placed within the inner cavity 4, there is provided a space (not shown) between the hardboiled egg 10 and the inner wall 4. Preferably, according to an embodiment the inner cavity 4 in the apparatus 1 has a three-dimension profile of an ovoid or a sphere, with the inner wall 5 surrounding the hardboiled egg 10 accommodated therein. More preferably, three-dimensional profile of the inner cavity is egg-shaped.

The eggshell peeling apparatus 1 further includes one or more water outlets 6 which communicate fluidically with the inner cavity 4. For example, the one or more water outlets may be one or more open slots or holes provided on the first or second body portions 2, 3, so that the water filled in the inner cavity 4 may be drained to the exterior of the apparatus 1 during operation. Preferably, the inner wall 5 provides a collision surface 5′ that is substantially smooth and free of protrusions. The collision surface 5′ is essentially the surface of the inner wall 5 and is a smooth surface with a curvature conforming to the natural curvature of an egg.

The size of eggs being sold on the market is categorized by their weight but not the actual dimension of the eggs. The egg size stated on the package tells the minimum net weight of the eggs in the package. Advantageously, the shape and size of the inner cavity 4 are arranged to accommodate small to jumbo size (i.e., USDA standard) poultry eggs with diameters of about 40 mm to 45 mm and a height of about 53 mm to 61 mm. More preferably, the size of the inner cavity 4 is arranged such that amount of the space between the hardboiled egg 10 and the inner wall 5 would not exceed 5 mm on average. This space provides a collision distance for the egg 10 to impact against the inner wall during operation of the apparatus 1. Preferably, the apparatus 1 would be made of glass or ceramic material. With the higher hardness of glass or ceramic, the collision of the eggshell against the inner wall 5 would be more effective than that of having the apparatus made of plastic or resin-like material. For example, with the apparatus 1 made of glass, the impact distance required for effective collision to fracture the eggshell would be shorter, resulting in a more effective collision within the cavity for cracking the eggshell, yet minimizing the size of the apparatus 1.

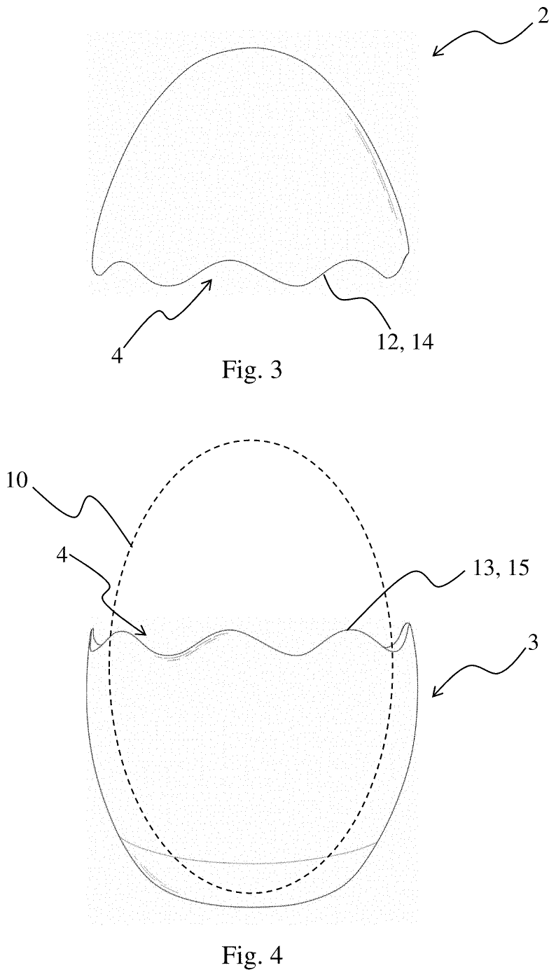

Referring further to FIG. 3 and FIG. 4, the first body portion 2 forms an upper part of the eggshell peeling apparatus 1, and the second body portion 3 forms a lower part thereof. The second body portion 3 has a rounded semi-spherical shape interior which conforms to the rounded and wider end (not shown) of the hardboiled egg 10 which it receives, while the first body portion 2 has a pointed ovoid shape which conforms to the tapered or narrower end of the egg 10. The first and second body portions 2, 3 are provided with first and second coupling ends 12, 13, respectively. The first and second coupling ends 12, 13 extend around the circumference of the eggshell peeling apparatus 1 and about a central longitudinal axis A of the apparatus 1 as shown FIG. 1.

The first and second coupling ends 12, 13 are complementary to each other in such a way that enables the first body portion 2 to be detachably coupled with the second body portion 3. The first and second coupling ends 12, 13 may be arranged to form a junction 11 between the first and second body portions 2, 3. Specifically, the junction 11 is a non-sealing junction which allows passage of fluid, i.e., water, from within the inner cavity 4 to the exterior. Preferably, the non-sealing junction 11 also functions as one or more water outlets 6 that allow passage of water from the inner cavity 4 to the exterior or vice versa.

According to an embodiment, the first and second coupling ends 12, 13 are further arranged to prevent relative rotation between the first and the second body portions 2, 3. Specifically, each of the first and second coupling ends 12, 13 are provided with a wavy or zigzag interfacing edge 14, 15. The interfacing edges 14, 15 are complementary to each other and together form the non-sealing junction 11 extending around the circumference of the eggshell peeling apparatus 1. As shown in FIG. 1, the non-sealing junction 11 has a wavy or zigzag shape.

During use, a hardboiled egg 10 is put in the inner cavity 4 by first placing the same in the lower or second body portion 3, with the rounded end (not precisely shown) of the hardboiled egg 10 being accommodated therein. Following the placement of the hardboiled egg 10, water is filled into the inner cavity 5 while the first and the second body portions are being coupled together. This can be done by first filling water in either one of the first or second body portions 2, 3, placing the eggshell peeling apparatus 1 under a stream of water, or submerging the apparatus 1 under water. The water acts as a lubricant and facilitates the separation of the eggshell from the egg white.

Then, with the first body portion 2 coupled to the second body portion 3, the apparatus 1 is subjected to a back and forth oscillating action, i.e., by shaking the apparatus, preferably in a direction along or substantially parallel to the longitudinal axis A of the eggshell peeling apparatus 1. The back and forth oscillating action resulted by the shaking causes the hardboiled egg 10 in the inner cavity 4 to collide against the inner wall 5 repetitively, for the purpose of cracking the eggshell. As a result of the repeated collisions, the eggshell of the hardboiled egg 10 would be fractured and partially separated from the egg white. During shaking, the force acts on the entire surface of the eggshell causing the eggshell to fracture and the egg white to deform. Preferably, with the inner cavity 4 being egg shaped, it provides multiple points of contact for spreading out the force of impact which can effectively minimize breakage of the egg white.

In the processing of collisions between the hardboiled egg 10 and the inner wall 5, the presence of water within the inner cavity 4 provides a dampening effect which slows down the movement of the egg 10. Preferably, the shaking action is maintained for approximately three to five seconds in order to fracture the eggshell sufficiently for subsequent removal by the user. In the course of the back and forth oscillating action of the apparatus 1, the water from within the inner cavity 4 would be forced to drain out of the inner cavity 4 gradually through the one or more water outlets 6. The gradual decreasing of water volume within the inner cavity 4 during the collision process would gradually lower the dampening effect for the collision between the egg 10 and the inner wall 5, while allowing the eggshell of the hardboiled egg 10 to fracture incrementally. For example, at the beginning of the shaking, the collision between the eggshell and the inner wall 5 is relatively milder as water volume is providing more dampening for the collision. As water is being drained from the inner cavity 5 through the water outlet 6 during the collision process, the decreased water volume lowers the dampening effect and results in increasingly harder collisions between the eggshell and the inner wall 5. The gradual decreasing in dampening effect in the collision process is particularly advantageous in fracturing the eggshell and separating the eggshell from the egg white since the fractured eggshell, which is held together by a membrane, itself could provide a certain degree of dampening. As a result, a relatively harder collision force would often be required to fracture the remaining portions of the eggshell. Therefore, gradually decreasing the dampening effect produced by the water within the inner cavity would serve to compensate for the additional and increasing dampening effect provided by the fractured eggshell. This results in a more effective and consistent collision process for fracturing the entire eggshell evenly and achieving separation of the eggshell from the bare egg.

Upon the water is substantially drained out of the eggshell peeling apparatus 1, the hardboiled egg 10 may be retrieved by decoupling the first and second body portions 12, 13. Once the egg 10 is retrieved, the fractured eggshell may be separated or removed from the egg white by tearing the eggshell membrane. As a result of using the eggshell peeling apparatus 1, the fractured eggshell can be easily removed in its entirety by tearing the eggshell membrane which carries the fractured eggshell fragments therewith.

Preferably, for even better results, the hardboiled egg 10 would be first cooled by cool water before placing in the eggshell peeling apparatus 1. The cold water serves to cool the outer surface of the hardboiled egg 10 and thus making the eggshell contracts. With the egg white still warm, the egg white continues to expand which puts additional stress on the cooled eggshell and the membrane. During repeatedly collisions within the eggshell peeling apparatus 1, the eggshell, subjecting to the said stress, would fracture more evenly and cause the membrane to rupture. As a result, the eggshell of the hardboiled egg 10 would be readily separated from the egg white and can be manually removed entirely with ease.

It should be understood that the above only illustrates and describes examples whereby the present invention may be carried out, and that modifications and/or alterations may be made thereto without departing from the spirit of the invention. It should also be understood that certain features of the invention, which are, for clarity, described in the context of separate embodiments, may also be provided in combination in a single embodiment. Conversely, various features of the invention which are, for brevity, described in the context of a single embodiment, may also be provided separately, or in any suitable subcombination.

All references specifically cited herein are hereby incorporated by reference in their entireties. However, the citation or incorporation of such a reference is not necessarily an admission as to its appropriateness, citability, and/or availability as prior art to/against the present invention.

It should be noted that although the specification is described in terms of embodiments, not every embodiment includes only a single technical solution. This description of the specification is merely for the sake of clarity. Those skilled in the art should regard the specification as a whole, and the technical solutions in the embodiments can also be combined appropriately to form other embodiments that can be understood by those skilled in the art. However, the protection scope of the present invention is defined by the appended claims rather than the foregoing description, and it is therefore intended that all changes that fall within the meaning and scope of equivalency of the claims are included in the present invention and any reference signs in the claims should not be regarded as limiting the involved claims.

What is claimed is:

1. An apparatus for assisting removal of the eggshell of a hardboiled egg, comprising:
a first body portion;
a second body portion detachably couplable to the first body portion, upon coupling the first and second body portions form an inner cavity for receiving a hardboiled egg;
wherein the inner cavity comprises an inner wall complementary to the shape of the hardboiled egg, the inner cavity is arranged to provide a space between the hardboiled egg and the inner wall, and
the eggshell peeling apparatus further comprises one or more water outlets in fluidic communication with the inner cavity.

2. The apparatus according to claim 1, wherein the inner cavity has a three-dimension profile resembling an egg-shape, with the inner wall evenly surrounding the hardboiled egg received therein.

3. The apparatus according to claim 1, wherein the inner wall provides a collision surface, the collision surface is substantially smooth and free of protrusions.

4. The apparatus according to claim 1, wherein the inner cavity is arranged to accommodate a poultry egg of small to jumbo sizes.

5. The apparatus according to claim 4, wherein the inner cavity is further arranged such that a distance measured from the inner wall to a surface of the hardboiled egg does not exceed 5 mm on average.

6. The apparatus according to claim 1, wherein the first and second body portions are provided with first and second coupling ends, respectively, the first and second coupling ends are complementary to each other.

7. The apparatus according to claim 6, wherein the first and second coupling ends are arranged to prevent relative rotation between the first and the second body portions.

8. The apparatus according to claim 7, wherein the first and second coupling ends form a non-sealing junction between the first and second body portions.

9. The apparatus according to claim 8, wherein the at least one water outlet is formed at the non-sealing junction.

10. The apparatus according to claim 8, wherein the non-sealing junction has a wavy or zigzag shape extending around the circumference of the apparatus.

11. The apparatus according to claim 1, wherein the inner cavity has a three-dimensional profile of an ovoid or a sphere.

12. The apparatus according to claim 1, wherein the first and the second body portions are made of glass or ceramic.

13. A method of removing an eggshell of a hardboiled egg comprising the steps of:
a) providing an apparatus according to any one of the preceding claims;
b) placing the hardboiled egg in the second body portion;
c) filling the apparatus with water for providing a dampening effect for the collision between the eggshell and the inner wall;
d) coupling the first body portion with the second body portion with the first and second coupling ends in complement to each other;
e) shaking the apparatus thus fracturing the eggshell of the hardboiled egg;
f) separating the first body portion from the second body portion;
g) removing the hardboiled egg from the eggshell peeling apparatus; and
h) removing the fractured eggshell from the hardboiled egg,
wherein the step of shaking the apparatus causes the eggshell to collide repeatedly with the inner wall of the inner cavity while induces a gradual evacuation of the water through the one or more water outlets.

14. The method of peeling an eggshell from a hardboiled egg according to claim 13, wherein in step e) the shaking of the apparatus is performed in a direction substantially parallel to a longitudinal axis of the apparatus.

15. The method of peeling an eggshell from a hardboiled egg according to claim 14, wherein step e) is completed only when the water in the apparatus has been substantially drained.
